(19) United States
(12) Patent Application Publication
(10) Pub. No.: US 2010/0192575 A1
(43) Pub. Date: Aug. 5, 2010

(54) PROCESS AND SYSTEMS

(76) Inventors: Abdulsalam Al-Mayahi, Worcester Park Surrey (GB); Mohammed S. Aljohani, Jeddah (SA)

Correspondence Address: HAYES SOLOWAY P.C., 3450 E. SUNRISE DRIVE, SUITE 140, TUCSON, AZ, 85718, US

(21) Appl. No.: 12/679,010

(22) PCT Filed: Sep. 22, 2008
(86) PCT No.: PCT/GB08/50851

§ 371 Date: Mar. 18, 2010

(30) Foreign Application Priority Data
Sep. 20, 2007 (GB) 0718334.6
Sep. 21, 2007 (GB) 0718463.3
Oct. 8, 2007 (GB) 0719514.2

(51) Int. Cl. F01K 25/10; C02F 1/44

(52) U.S. Cl. 60/671; 210/321.66; 210/652

(57) ABSTRACT

An apparatus for recovering energy from an osmotic system, said apparatus comprising: (i) a feed stream (143,251); (ii) pressure means (140,150, 250, 254) to pressurise said feed stream; (iii) a manipulated osmosis unit (110,220,230); (iv) an energy recovery unit (120, 240, 260) in fluid connection with second solution side of the manipulated osmosis unit; (v) a reverse osmosis unit (130) receiving a feed from the energy recovery unit.

### FIELD OF THE INVENTION

The present invention relates to methods and apparatus for a solvent removal process by a pressure driven process at lower applied pressure utilizing Manipulated Osmosis (MO) and Reverse Osmosis (RO) combined with Energy Recovery Devices (ERD), to methods and apparatus for osmotic energy recovery utilizing Energy Recovery Turbines with forward osmosis units, and to methods and apparatus for transforming energy from a heat source into a usable form using a working fluid such as ammonia—water that is expanded and regenerated. Embodiments of this invention further relate to a method and apparatus for improving the heat utilization efficiency of a thermodynamic cycle. The present invention utilizes an Energy Recovery Turbine, which is an Energy Recovery Device (ERD), in the cycle to maintain the working fluid, for example ammonia-water solution at a similar level of concentration) between the evaporator (boiler) and the condenser (absorber) by linked them together through a heat exchanger in conjunction with an Energy Recovery Turbine

### BACKGROUND TO THE INVENTION

Forward Osmosis (FO) or Manipulated Direct Osmosis (MDO) processes, and their related applications, are well described in WO 2005/012185 and WO 2005/120688 in the name of University of Surrey and in my UK filed patent no. 0718334.6 dated on 20 Sep. 2007. In addition, a number of seawater and brackish water desalination applications are explained and described in WO 2005/012185, and cooling tower water treatment applications using FO are explained in WO 2005/120688. The text of WO2005/012185 and WO2005/120688 are hereby imported by reference and are intended to form an integral part of this description. This description should be read, and the terms of this description should be understood, in relation to the disclosure in those earlier documents.

In my patent No. 0718334.6 dated on 20 Sep. 2007, many novel options for producing fresh water from solar ponds and cooling towers have been discussed, based upon utilizing FO & Energy Recovery Devices ERDs.

Energy Recovery Devices are used for energy recovery from a high pressure liquid stream to another liquid stream at lower pressure, such as a hydraulic energy exchanger located between a high-pressure rejected stream and a low-pressure feed stream in reverse osmosis RO plants. There are many types of commercial ERDs available in the market such as Pelton turbines, Hydraulic Turbochargers, Piston Isobaric and Rotary Isobaric devices.

Energy Recovery Turbines or Turbo Chargers are examples of energy recovery devices which could be used with this invention. FEDCO and Pump Engineering Inc (PEI) are both producing these types of ERDs. Today, thousands of ERDs from different manufacturers are used in desalination plants around the world to save energy, especially with seawater RO plants. It should be understood that the system designer will select the most suitable ERD for the application involved.

Generally, fresh water is produced from seawater or brackish water by a RO process which requires high pressure applied to the membrane in the reverse osmosis unit in order to separate the solvent (water). The amount or magnitude of the applied pressure is mainly dependent on the feed's osmotic pressure and the design recovery ratio of the plant. For example, seawater of TDS between 30,000-50,000 ppm could be treated by RO to produce fresh water by applying a pressure between 50-80 bar with a recovery ratio between 30-50%. Using such a high-pressure process will have an impact on the cost because of the highly costly pressure pumps required and operating costs to run them. Consequently, achieving an RO process with lower working pressures is considered to be imperative as it impacts on both fixed and operational costs. If a lower operating pressure can be achieved then less expensive lower pressure pipework and fittings could be used.

### SUMMARY OF THE INVENTION

According to a first aspect of the present invention there is provided an apparatus for recovering energy from an osmotic system, said apparatus comprising:—
(i) a feed stream;
(ii) pressure means to pressurise said feed stream;
(iii) a manipulated osmosis unit working according to reverse osmosis principles;
(iv) an energy recovery unit in fluid connection with second solution side of the manipulated osmosis unit;
(v) a reverse osmosis unit receiving a feed from the energy recovery unit.

This arrangement allows a pure solvent stream to be produced at lower operating pressures than would otherwise be possible, by recovering energy as the various liquid streams circulate.

Preferably said manipulated osmosis unit houses a selective membrane for separating a first solution from a second solution, said membrane being configured to selectively allow solvent to pass from the first solution side of the membrane to the second solution side of the membrane.

Preferably the reverse osmosis unit houses a second selective membrane for separating a third solution from a fourth solution, said second membrane being configured to selectively allow solvent to pass from the said third solution to said fourth solution.

Preferably the pressure means comprises a pump. A pump is required to generate the pressure required to operate the manipulated osmosis unit.

Preferably the pressure means further comprises an energy recovery unit, which may augment the pump.

In a particularly preferred embodiment the pressure means comprises an energy recovery unit and a pump.

Preferably the energy recovery unit comprises an energy recovery turbine.

Preferably said apparatus further comprises a second manipulated osmosis unit and preferably the first and second manipulated osmosis units are connected in a loop.

Preferably the second manipulated osmosis unit houses a third selective membrane for separating a fifth solution from a sixth solution, said membrane being configured to selectively allow solvent to pass from the fifth solution side of the membrane to the sixth solution side of the membrane.

Preferably a feed stream is provided to the first solution in said first manipulated osmosis unit and said second solution provides a feed to the fifth solution in said second manipulated osmosis unit.

Preferably said feed to the fifth solution proceeds via an energy transfer means.

Preferably said sixth solution provides a feed to the third solution in the reverse osmosis unit.

Preferably said feed proceeds to the reverse osmosis unit via a pump.

Where two manipulated osmosis units are provided, it is preferred that the apparatus further comprises a second energy recovery unit.

Preferably the second energy recovery unit is in fluid connection with the second manipulated osmosis unit and with the reverse osmosis unit.

Preferably one or more of the energy recovery units comprise an energy recovery turbine.

According to a second embodiment of the first aspect of the present invention there is provided a process for recovering energy from an osmotic system, said process comprising:—
(i) positioning a selective membrane in a manipulated osmosis unit between a first solution and a second solution, such that the solvent from the first solution passes across the membrane to dilute the second solution;
(ii) providing a feed stream to the first solution in the manipulated osmosis unit operating according to reverse osmosis principles;
(iii) extracting solvent from the second solution using a reverse osmosis unit, a feed line connecting the second solution in the manipulated osmosis unit and the reverse osmosis unit;
(iv) providing an energy recovery unit in the feed line between the manipulated osmosis unit and the reverse osmosis unit.

Preferably a pressure means is provided to pressurise the feed stream into the manipulated osmosis unit.

Preferably the pressure means comprises either a pump, or an energy transfer means, or both.

Preferably the second solution from the manipulated osmosis unit is directed to a second manipulated osmosis unit.

Preferably the first manipulated osmosis unit and the second manipulated osmosis unit are connected in a loop.

Preferably energy recovery units are positioned/located between the respective osmosis units.

In summary this embodiment of the invention, in one sense, involves providing and operating an apparatus according to the first aspect of the invention as set out above and as described in more detail below.

Therefore, in an embodiment of the first aspect of the present invention, fresh water may be produced via a membrane method (pressure driven process), such as RO desalination for both seawater and brackish water using a lower applied pressure in comparison with higher pressures required in conventional RO plants in which the same or similar osmotic—potential solution is used. The lower operation pressure may be achieved by using Manipulated Osmosis MO and RO in conjunction with ERD. The MO unit's features are similar to those of FO units with the exception of applying higher pressure on the feed side to reverse the effect of the osmotic potentials resultant of the two solutions, allowing the solvent (typically water) to move from the feed solution to the manipulated solution side. The direction of water flow inside the MO unit in this invention will be from the feed side (high salt concentration) to the manipulated side (low salt concentration) and could be observed as a reverse osmosis process. As a result, the required applied pressure for a certain water flux through the membrane of the MO unit from the feed side to the manipulated solution side will be lower in comparison with the required applied pressure if RO is used alone, without use of a manipulated solution according to this invention. The following equation could represent the resultant effecting pressure on both sides of the membrane inside the MO unit:

=ΣΔP_{osmotic}+ΣΔP_{applied}

The manipulated osmosis unit has a semi-permeable membrane (selective membrane) separating a first solution (the feed) and a second solution (the manipulated solution). The osmotic potential (solutes concentration) of the feed solution (first solution) is higher than the osmotic potential (solutes concentration) of the manipulated solution (second solution). That means the solvent (water) moves across the selective membrane from a first to a second solution only when an external pressure exceeding the potential difference the two solutions are applied.

Water may also be separated from seawater by reverse osmosis. In reverse osmosis, seawater is placed on one side of a semi-permeable membrane and subjected to pressures of 5 to 8 MPa. The other side of the membrane is maintained at atmospheric pressure. The resulting pressure differential causes water to flow across the membrane, leaving a salty concentrate on the pressurized side of the membrane.

Typically, these semi-permeable membranes have an average pore size of, for example, 1 to 5 Angstroms. After a period of operation, the pores of the semi-permeable membrane may become obstructed by deposited salts, biological contaminants and suspended particles in the seawater. Thus, higher pressures may be required to maintain the desired level of flow across the membrane. The increased pressure differential may encourage further clogging to occur. Thus, the membranes must be cleaned and replaced at regular intervals, interrupting the continuity of the process and increasing operational costs.

Any suitable selective membrane may be used in the process of the present invention. The membrane may have an average pore size of 1 to 80 Angstroms, preferably, 1 to 20 Angstroms, more preferably, 5 to 10 Angstroms.

Suitable selective membranes include integral membranes and composite membranes. Specific examples of suitable membranes include membranes formed of cellulose acetate (CA) and membranes formed of polyamide (PA). Preferably, the membrane is an ion-selective membrane. Conventional semi-permeable membranes may also be employed.

The membrane may be planar or take the form of a tube or hollow fibre. If desired, the membrane may be supported on a supporting structure, such as a mesh support. The membrane may be corrugated or of a tortuous configuration.

In one embodiment, one or more tubular membranes may be disposed within a housing or shell. The first solution may be introduced into the housing, whilst the second solution may be introduced into the tubes. As the solvent concentration of the first solution is lower than that of the second, solvent will diffuse across the membrane from the first solution into the second solution when external pressure is applied to achieve the reverse osmosis process. Thus, the second solution will become increasingly diluted and the first solution, increasingly concentrated. The diluted second solution may be recovered from the interior of the tubes, whilst the concentrated first solution may be removed from the housing.

When a planar membrane is employed, the sheet may be rolled such that it defines a spiral in cross-section.

In a preferred embodiment, the first solution comprises a plurality of solutes such as seawater or fruit juice, whilst the second solution is formed by dissolving one or more known solutes in a solvent.

Preferably, the second solution has a known composition.

For example, the second solution is formed by introducing a known quantity of a solute into a known quantity of solvent. Preferably, the second solution consists essentially of a selected solute dissolved in a selected solvent. By forming the second solution in this manner, a substantially clean solution may be produced.

Preferably, the second solution has a reduced concentration of suspended particles, biological matter and/or other components that may cause fouling of the apparatus used to extract solvent from the second solution. More preferably, the second solution is substantially free of such components. Thus, membrane techniques may be used to extract solvent from the second solution without fear of the pores of the membrane being subjected to unacceptably nigh levels of fouling, for example, by biological matter or suspended particles.

The solvent in the second solution is preferably water.

The solute (osmotic agent) in the second solution is preferably a water-soluble solute, such as a water-soluble salt. Suitable salts include ammonium salts and metal salts, such as alkali metals (e.g. Na, K) and alkaline earth metals (e.g. Mg and Ca). The salts may be fluorides, chlorides, bromides, iodides, sulphates, sulphites, sulphides, carbonates, hydrogencarbonates, nitrates, nitrites, nitrides, phosphates, aluminates, borates, bromates, carbides, perchlorates, hypochlorates, chromates, fluorosilicates, fluorosilicates, fluorosuiphates, silicates, cyanides and cyanates. One or more salts may be employed.

As the second solution circulates in a substantially closed loop, additional additives selected from, for example, scale inhibitors, corrosion inhibitors, biocides and/or dispersants may be added to the closed loop to enhance the separation process in the manipulated osmosis MO and in the Reverse osmosis RO units.

For example, in one embodiment of the first aspect of the present invention untreated seawater (first solution) is pumped to enter one side of the membrane in a MO unit to achieve a reverse osmosis process, whereas a less concentrated manipulated solution (second solution) at a lower applied pressure enters the other side of the membrane. Due to the resultant differences of osmotic and applied pressures between the two sides of the membrane, the solvent (water) passes across the membrane from the feed side to the process (manipulated) side and accordingly makes the manipulated solution (second solution) more diluted. The high concentration stream (rejected seawater) leaves the MO unit at a high pressure to enter the ERD and transfers its hydraulic (pressure) energy to the outlet manipulated stream (diluted). The diluted manipulated stream gains a pressure or hydraulic energy through the ERD, before entering the RO unit for treatment. Fresh water can be collected from the RO as a permeate whereas the rejected stream (concentrated second solution) leaves the RO at a high pressure and enters another ERD to transfer its hydraulic energy to the seawater (first solution)(which should be pumped to a sufficient pressure by the main pump to achieve the reverse osmosis in the two membrane units (MO & RO units). FIG. 1 illustrates this process.

In a second preferred embodiment of this aspect of the present invention, certain additives can be added to the manipulated solution and immobilised in a substantially closed loop. These immobilised additives for example could be antiscalants, biocides and cleaning chemicals.

In a third preferred embodiment of this aspect of the present invention, a controlled pore size membrane with larger pore size similar to the nano filtration NF membrane can be used in the MO unit and or in the RO unit to enhance the water flux through the membranes of the MO and RO units.

Accordingly, nanofiltration membranes may be employed to extract solvent from the second solution.

Nanofiltration is particularly suitable for separating the large solute species of the second solution from the remainder of the solution.

Suitable nanofiltration membranes include cross-linked polyamide membranes, such as crosslinked aromatic polyamide membranes. The membranes may be cast as a “skin layer” on top of a support formed, for example, of a microporous polymer sheet. The resulting membrane has a composite structure (e.g. a thin-film composite structure).

Typically, the separation properties of the membrane are controlled by the pore size and electrical charge of the “skin layer”. The membranes may be suitable for the separation of components that are, for example, 0.01 to 0.001 microns in size with molecular weights of 100 gmol-1 or above, for example, 200 gmol-1 and above.

As well as filtering particles according to size, nanofiltration membranes can also filter particles according to their electrostatic properties. For example, in certain embodiments, the surface charge of the nanofiltration membrane may be controlled to provide desired filtration properties. For example, the inside of at least some of the pores of the nanofiltration membrane may be negatively charged, restricting or preventing the passage of anionic species, particularly multivalent anions.

Examples of suitable nanofiltration membranes include Desal-5 (Desalination Systems, Escondido, Calif.), NF 70, NF 50, NF 40 and NF 40 HF membranes (FilmTech Corp., Minneapolis, Minn.), SU 600 membrane (Toray, Japan) and NRT 7450 and NTR 7250 membranes (Nitto Electric, Japan).

The nanofiltration membranes may be packed as membrane modules. By way of example, spiral wound membranes, and tubular membranes for example enclosed in a shell may be employed.

In a fourth preferred embodiment of this aspect of the present invention, multi MO units can be used in sequence to decrease the applied working pressure. FIG. 2 illustrates this process.

In a fifth preferred embodiment of this aspect of the present invention, food solutions such as fruit juices or dairy products can be concentrated.

RO is a more cost-effective process for concentrating food liquids (such as fruit juices) than conventional heat-treatment processes. Besides the lower operating costs advantages of the present invention, these methods avoid heat treatment processes, which makes them suitable for treating heat-sensitive substances such as the proteins and enzymes found in most food products.

RO is extensively used in dairy industry for the production of whey protein powder and for the concentration of milk to reduce shipping costs. Accordingly, the feed enters the manipulated unit at low concentration and leaves at higher concentration whereas the extracted solvent (water) can be collected as a permeate from the RO unit.

Pharmaceutical solutions can be concentrated by the same means and in the same manner.

According to a second aspect of the invention there is provided an osmotic energy recovery apparatus, said apparatus comprising:—
(i) a first feed stream;
(ii) a first, forward osmosis unit;
(iii) a first energy transfer means located on an exit stream from the forward osmosis unit;
(iv) a second, reverse osmosis unit;
(v) a second energy transfer means located adapted to derive energy from the high pressure side of the reverse osmosis unit.

Preferably said forward osmosis unit houses a first selective membrane for separating a first solution from a second solution, said first membrane being configured to selectively allow solvent to pass from said first solution to said second solution and thus to build up pressure in the second solution.

Preferably said second osmosis unit houses a second selective membrane for separating a third solution from a fourth solution, said second membrane being configured to selectively allow solvent to pass from said fourth solution to said third solution; said second osmosis unit receiving a feed stream pressurised by the energy transfer means.

Preferably the apparatus further comprises a solar pond, said solar pond receiving the second solution from the first osmosis unit by way of the first energy transfer means.

Preferably the apparatus further comprises a pump to raise water from the solar pond.

Preferably the apparatus further comprises a desalination plant, said desalination plant receiving the second solution from the first osmosis unit by way of the first energy transfer means.

Preferably the apparatus further comprises a pump to deliver a fluid stream from the desalination plant towards the first osmosis unit via the second energy transfer means.

Preferably the second solution in the first osmosis unit, the first energy transfer means, and the second energy transfer means form a loop.

In an alternative preferred embodiment the apparatus further comprises a cooling tower and preferably the second solution in the first osmosis unit, the first and second energy transfer means and the cooling tower form a loop.

According to a second embodiment of the second aspect of the present invention there is provided a process for recovering energy from an osmotic system said process comprising:—
(i) providing a first, forward osmosis unit;
(ii) providing a second, reverse osmosis unit;
(iii) providing a first energy transfer means to transfer energy from an output stream from the forward osmosis unit to an input stream to the reverse osmosis unit;
(iv) providing a second energy transfer means to transfer energy from an output stream from the reverse osmosis unit to an input stream to the forward osmosis unit.

Preferably said first osmosis unit houses a first selective membrane for separating a first solution from a second solution, said first membrane being configured to selectively allow solvent to pass from said first solution to said second solution, and thus build up pressure in the second solution.

Preferably said reverse osmosis unit houses a second selective membrane for separating a third solution from a fourth solution, said second membrane being configured to selectively allow solvent to pass from said fourth solution to said third solution.

Preferably the process involves providing a solar pond, said solar pond receiving an output from the forward osmosis unit by way of the first energy transfer means.

Preferably a pump is located between the solar pond and an input to the forward osmosis unit to raise water from the pond.

In an alternative preferred embodiment the process involves providing a desalination plant, said desalination plant receiving an output from the forward osmosis unit by way of the first energy transfer means.

Preferably a fluid loop is created between a more concentrated solution side of the forward osmosis unit, a first energy transfer means, a source of concentration such as solar pond, desalination plant or a cooling tower, a second energy transfer means, returning to the more concentrated solution side of the forward osmosis unit, said loop providing energy to an input stream for the reverse osmosis unit and deriving energy from an output stream from the reverse osmosis unit.

Preferably an output stream from a more dilute solution side of the reverse osmosis unit is directed as a feed into a more dilute side of the forward osmosis unit.

In summary, this embodiment of the invention, in one sense, involves providing and operating an apparatus according to the second aspect of the invention as set out above and as detailed below.

Therefore, according to a second aspect of the present invention, fresh water may be produced via membrane methods, such as RO, from solar ponds. Generally solar ponds have a very high concentration of salt solution due to the continuous natural water evaporation caused by solar heating. This high concentration is considered to be a good source of a driving force that can create high osmotic pressure due to the water flow through a selective semi-permeable membrane, which is placed in the Forward Osmosis FO unit, as described in patents WO 2005/012185 and WO 2005/120688.

The influx of liquid across the selective membrane generates pressure (e.g. hydrostatic pressure) in the solution. The pressurised solution leaving the FO is used directly to extract its hydraulic energy via Energy Recovery turbine that can transfer the hydraulic energy from the FO outlet to another stream (such as the untreated solution input stream to a reverse osmosis unit).

Any suitable selective membrane may be used in the FO unit the membrane may have an average pore size of 1 to 60 Angstroms, preferably 2 to 50 Angstroms.

The average pore size of the membrane is preferably smaller than the size of the solutes in the solution.

Advantageously, this prevents or reduces the flow of solute across membrane by diffusion, allowing liquid to flow across the membrane along the osmotic (entropy) gradient. The flux of liquid across the membrane is influenced by the pore size of the membrane. Generally, the larger the pore size, the greater the flux.

Suitable selective membranes include integral membranes and composite membranes. Specific examples of suitable membranes include membranes formed of cellulose acetate (CA) and membranes formed of polyamide (PA). Preferably, the membrane is an ion-selective membrane. Conventional semi-permeable membranes may also be employed.

The membrane may be planar or take the form of a tube or hollow fibre. If desired, the membrane may be supported on a supporting structure, such as a mesh support. The membrane may be corrugated or of a tortuous configuration.

An Energy Recovery Turbine can extract most of the hydraulic energy from the high pressure outlet which leaves the Forward Osmosis unit after being diluted there. Ideally, the Energy Recovery Turbine operates to transfer the hydraulic energy from the high pressure stream to another stream, which could be any untreated water stream. This untreated water is pressurised to enter the RO unit, thus producing fresh water with less dissolved salts and contaminants. Another Energy Recovery Turbine can be implemented to transfer the hydraulic energy from the rejected stream of this RO unit to the highly concentrated stream coming from the solar pond or from any other re-concentrating means, such as thermal concentrators, which is in turn pressurised to enter the Forward Osmosis unit. FIG. 4 and its associated key illustrate this process.

In a second preferred embodiment of this aspect of the present invention, fresh water can be produced from thermal desalination plants, such as Multi-Stage Flash (MSF), Multi Effect Distillation (MED) and Mechanical Vapour Compression (MVC) plants or any concentrator means such RO rejected streams. In this embodiment the high concentration stream from the MSF, MED, MVC and RO reject replaces the high concentration stream from the solar pond to derive the process of producing fresh water. The description of this method is similar to that described in the first embodiment above and is shown in FIG. 5.

In a third embodiment of this aspect of the present invention that is summarised in FIG. 6, along with applying cooling towers to different water sources such as waste water, industrial water, agriculture water, brackish water, or seawater, can be used to produce fresh water. In general, all evaporative cooling tower's water have a high concentration of salts, and these solutions can be fed to the Forward Osmosis unit. This concentrated solution is diluted by passing into the Forward Osmosis unit, due to water passage through the semi-permeable membrane, into order to balance the osmotic potential between the two sides of membrane. Application of an Energy Recovery Turbine allows the transfer of hydraulic energy from the higher concentration stream coming out from the Forward Osmosis unit, to the lower concentration stream leaving the Forward Osmosis unit. The pressurised stream coming out of the Energy Recovery Turbine enters the RO Unit, resulting in fresh water permeation. The rejected stream from the RO unit however, enters another Energy Recovery Turbine to pump the high concentrated cooling tower's solution into the forward osmosis unit.

A fourth embodiment of this aspect of the present invention is shown in FIG. 7 This describes using cooling tower water to augment the process described in the invention WO 2005/120688, by minimising or indeed, preventing any possibly serious contaminations in the forward osmosis unit and in the whole cooling tower unit. Another advantage of using the aforementioned arrangement is that fresh water can be produced.

In this method, fresh water is produced by the RO unit and is fed into the Forward Osmosis unit, hence minimising contamination in the Forward Osmosis unit and cooling tower, in addition to increasing the flux through the Forward Osmosis membrane. In a similar manner to that described above and detailed below, the rejected stream from the RO unit is used to pump a concentrated solution from a cooling tower into the forward osmosis unit by using an Energy Recovery Turbine. A second Energy Recovery Turbine is used to pump the cooling tower feed water into the RO unit, the Energy Recovery Turbine utilising the high pressure stream leaving the forward osmosis unit. An excess of fresh water can also be produced by this method, depending on the quality and concentration of the feed water.

According to a third aspect of the invention there is provided an ammonia-water engine apparatus, said apparatus comprising:—
(i) an evaporator containing a liquid solution of ammonia in water in the presence of a vapour over the liquid solution;
(ii) a heating source to heat the evaporator;
(iii) a turbine adapted to receive vapour from the evaporator;
(iv) a condenser adapted to condense vapour from the turbine to provide a condensate;
(v) an energy transfer means adapted to derive energy from a condensate stream on route from the evaporator to the condenser;
(vi) a heat exchanger adapted to heat the condensate stream.

Preferably the apparatus further comprises an auxiliary pump.

Preferably the apparatus further comprises a high pressure feed from the liquid in the evaporator to the heat exchanger, said feed passing through the energy transfer means where it leaves at a lower pressure on route to the condenser.

Preferably the turbine is connected to a pump, the energy from the turbine being used to drive the pump.

Preferably the turbine is connected to a vapour compressor, the energy from the turbine being used to drive the compressor.

In relation to the third aspect of the present invention, the Rankine cycle is the heating engine operating cycle used by all steam engines since the start of the industrial age. As with most engine cycles, the Rankine cycle is a four-stage process. Simply put, the working fluid (usually water) is pumped into a boiler. While the fluid is in the boiler, an external heat source superheats the fluid. The hot water vapour then expands to drive a turbine. Once past the turbine, the steam is condensed back into liquid and recycled back to the pump to start the cycle all over again. Pump, boiler, turbine and condenser are the four parts of a standard steam engine and represent each phase of the Rankine cycle. The organic Rankine cycle (ORC) is a non-superheating thermodynamic cycle that uses an organic working fluid to generate electricity. The working fluid is heated to boiling, and the expanding vapour is used to drive a turbine. This turbine can be used to drive a generator to convert the work into electricity. The working-fluid vapour is condensed back into liquid and fed back through the system to do the work again. The organic chemicals used by an ORC include Freon and most of the other traditional refrigerants such as isopentane, CFCs, HFCs, butane, propane and ammonia. Today, ORC systems are being evaluated to improve the working efficiency of distributed generation systems, to generate electricity from geothermal or solar natural heat sources, or to recover waste heat from industrial processes. The Kalina cycle uses ammonia/water as an organic working fluid which operates in a similar way to the Rankine cycle but with a higher efficiency.

Methods for converting the thermal energy of low grade energy sources (low temperature heat sources) into electric power present a significant area of potential power generation. There is a necessity for a method and apparatus for increasing the efficiency of the conversion of such low temperature heat to electric power that improves the efficiency of the standard Rankine cycles or the Kalina cycle. This invention presents such a method and apparatus.

The Kalina cycle is a modified Rankine cycle, or rather a reversed absorption cycle utilizing ammonia-water working fluid and patented by Exergy Inc and A. Kalina. The Kalina cycle is a thermodynamic cycle for converting thermal energy to mechanical power which utilizes a working fluid that is comprised of at least two components. The ratio between those components is varied in different parts of the system to increase thermodynamical reversibility and therefore increase thermodynamic efficiency. There are multiple variants of Kalina cycle systems specifically applicable for different types of heat sources.

The Kalina cycle has proved theoretically and practically to have higher efficiency than other Rankine cycles such as organic Rankine cycle (ORC) but at the same time there are inherent limitations and higher initial costs. The present invention could provide higher efficiency than a convention Kalina cycle using less equipment, leading to low fixed costs and higher output.

The Kalina cycle uses the four typical Rankine cycle phases: evaporation through the evaporator, expansion through the turbine, condensation by the absorber and liquid feed pumping back into the evaporator. The present invention presents a new cycle (Mayahi cycle) and uses three typical significant phases: evaporation, expansion and condensation whereas pumping the condensate by conventional pump is avoided by using a hydraulic Energy Recovery Turbine (Energy Recovery Turbine) and a heat exchanger (HE).

A hydraulic Turbo Charger (Energy Recovery Turbine) is an energy exchanger for transferring hydraulic energy between two liquid streams, wherein one stream is at a comparatively higher pressure than the other, comprising a suitable related centrifugal mechanism. An example where an Energy Recovery Turbine finds application is in the production of potable water using a reverse osmosis RO membrane process. In the RO process, a feed saline solution is pumped into a membrane unit at high pressure. The input saline solution is then divided by the membrane array into high concentration saline solution (brine) at high pressure and permeate water at low pressure. Whereas the high-pressure brine is no longer useful in this process as a fluid, the hydraulic or pressure energy that it contains is important. A hydraulic Energy Recovery Turbine is employed to recover the hydraulic energy (pressure energy) in the brine and transfer it to the feed saline solution. After transfer of the pressure energy in the brine flow, the brine is directed at low pressure to drain. For example, FEDCO and Pump Engineering Inc (PEI) are both producing those Energy Recovery Turbines and Turbo Chargers. Today, thousands of energy recovery devices are used in desalination plants around the world to save energy, especially with seawater RO plants.

For the time being, Turbo Chargers from PEI or Energy Recovery Turbines from FEDCO, among other available energy recovery devices, are the most practical choice to be implemented according to this patent. But they are not the only devices that could be used.

Thus, in accordance with an embodiment of this aspect of the present invention, a hydraulic Energy Recovery Turbine together with a heat exchanger are used in conjunction for an ammonia-water heat engine (power plant) instead of the conventional pump that is commonly used to pump the working fluid from the condenser (absorber) to the boiler (evaporator). The advantage of using a heat exchanger in conjunction with a hydraulic Turbo Charger (Energy Recovery Turbine) is that it minimises the heat losses through the mixing process between the contents of the boiler (evaporator) and the condenser (absorber). This Mayahi cycle can utilize any available energy sources for heating the evaporator (boiler) with a temperature range from 50° to 150° C. and most preferably with a temperature range from 80° to 120° C. Cooling the absorber can be achieved by any available cooling source with a temperature range from minus 20° to 50° C. Preferably, any available cooling source such as seawater, river water, cooling towers and air cooling can be employed.

Ammonia concentration in the Mayahi Engine can be varied from 10 to 90% in the liquid phase and the preferred concentration depends on the temperatures of heating and cooling. Generally, higher concentrations of ammonia means higher working pressure on both the boiler and the absorber according to the thermodynamic equilibrium between concentration, pressure and temperature.

Mayahi Cycle (Engine) efficiency, like any heat engine, is limited to the Carnot efficiency. The theoretical Carnot efficiency value of a cycle is equal to the temperature difference in degrees Kelvin between the high temperature in the boiler and low temperature in the condenser divided by the high temperature value of the boiler in Degree Kelvin. Practically, a Mayahi Engine could have a higher efficiency than previous engines due to the saving of the pumping energy for the condensate back to the boiler. Wasting this energy cannot be avoided in other cycles such as the Kalina cycle.

In a further preferred embodiment of this aspect of the present invention, the ammonia turbine is used to pump liquids instead of generating electricity. For example, untreated water for certain applications can be pumped, such as in membrane separation applications. This application has uses in pressure driven processes that are widely used in industry for water treatment, wastewater treatment, brackish water desalination and seawater desalination. Accordingly, a seawater desalination processes or other pressure driven processes could be achieved with minimal power consumption. Indeed, those processes can now utilize any available low grade energy source to run a Mayahi cycle (engine). The engine substitutes the requirement for an electrical power source to run the pump. In this case the Ammonia Turbine will produce mechanical energy in the form of a rotating shaft that can replace the electrical motor of a pump, which is preferably to be a centrifugal type,

In a still further preferred embodiment of this aspect of the present invention, the ammonia turbine could be used to compress gases instead of generating electricity. For example, water vapour (steam) for certain applications can be compressed using this engine, such as in a Mechanical Vapour Compression (MVC) desalination method. MVC is widely used for seawater desalination utilizing an electrically driven vapour compressor. Accordingly, a seawater desalination process based on vapour compression (VC) method could be achieved with minimal power consumption utilizing any available low grade energy sources to run a Mayahi cycle (engine) that replaces the otherwise required electrical power source to run the vapour compressor. In this case the Ammonia Turbine will be designed to produce mechanical energy in the form of rotating shaft that can replace the electrical motor of a compressor which is preferably of a centrifugal type.

### BRIEF DESCRIPTION OF THE DRAWINGS

The above aspects of this invention are more particularly described hereinafter, by way of example only, with reference to the accompanying figures and in which include:—

FIG. 1 is a schematic diagram for an RO plant to produce fresh water from seawater or brackish water by using a Manipulated Osmosis (MO) and energy recovery devices (ERD's);

FIG. 2 is a schematic diagram for an RO plant to produce fresh water from seawater or brackish water by using multi-stage Manipulated Osmosis (MO) units and energy recovery devices ERD's;

FIG. 3 shows the arrangement in FIG. 2 on to which have been superimposed typical operating pressures;

FIG. 4 is a schematic diagram illustrating fresh water production from solar ponds by using a Forward Osmosis unit and Energy Recovery Turbine;

FIG. 4a shows the arrangement in FIG. 4 on to which have been superimposed typical operating conditions;

FIG. 5 shows a system similar to that in FIG. 4 for fresh water production from a thermal desalination plant, by implementing a Forward Osmosis unit and Energy Recovery Turbine;

FIG. 6 shows a schematic diagram illustrating fresh water production from cooling towers using a Forward Osmosis unit and Energy Recovery Turbines;

FIG. 7 shows a schematic diagram for the treatment of cooling tower water using a Forward Osmosis unit and Energy Recovery Turbine;

FIG. 8 shows a schematic diagram for a Mayahi Cycle used to pump liquids for different applications utilizing low grade energy sources;

FIG. 9 shows a schematic diagram for a Mayahi Cycle used to compress gases for different applications utilizing low grade energy sources.

### DESCRIPTION OF THE PREFERRED EMBODIMENTS

Various aspects of the present invention will now be described by way of example only. These are not the only ways that the invention can be put into practice, but they are the best ways currently known to the applicant.

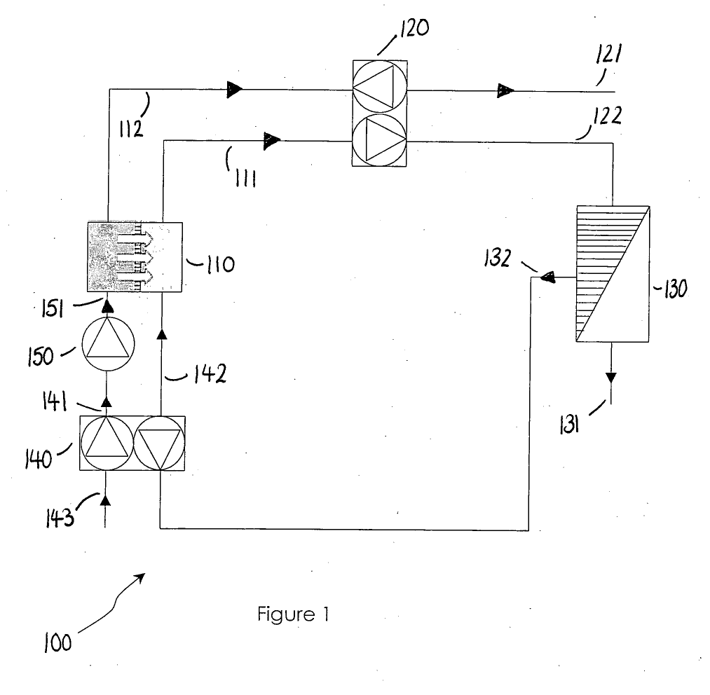

Referring to FIG. 1, this illustrates a solvent removal apparatus 100. A manipulated Osmosis MO unit 110 has two different concentration solutions separated by a semi-permeable membrane (selective membrane). Pumped seawater or brackish water at a high pressure enters unit 110 via line 151 and leaves via line 112 after losing some of its water, which passes through the membrane to the manipulated solution which has less osmotic pressure (less salt concentration). The concentrated high pressure stream 112 enters an energy recovery turbine 120, and in the process transferring its hydraulic energy, and leaves via line 121 as a rejected effluent. The diluted manipulated solution leaves 110 via line 111 to enter unit 120 gaining hydraulic energy and leaves at higher pressure via line 122 and enters an RO unit 130. In the RO unit 130 the diluted manipulated solution will be separated to two streams. A fresh water stream could be produced and collected via line 131 whereas the rejected stream leaves via line 132 at high pressure. The rejected stream enters another energy recovery turbine 140 transferring its hydraulic energy to the feed stream 143 and leaves via line 142 back to unit 110. Seawater or brackish water (the feed), enters the process via line 143 to the energy recovery turbine 140 gaining hydraulic energy and leaves at higher pressure via line 141 to enter the main pump 15. The pressurised feed leaves the pump 150 via line 151 to enter MO unit 110 where some of its water will pass through the membrane to the manipulated solution due to RO concept.

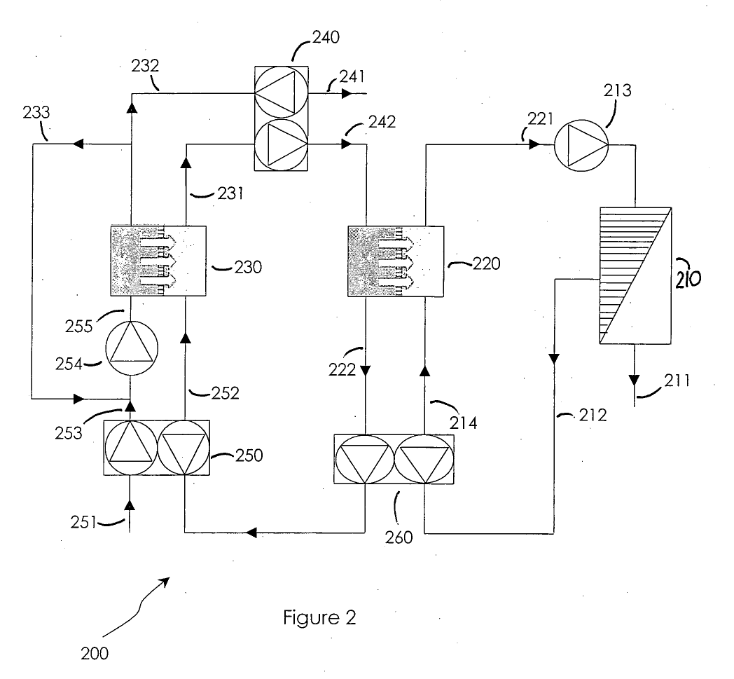

Referring to FIG. 2 this illustrates a further solvent removal apparatus and method 200. This embodiment includes two Manipulated Osmosis MO units and each Manipulated Osmosis MO unit, 230 or 220 has two different concentration solutions separated by semi-permeable membrane (selective membrane). First, the seawater or brackish water at high pressure enters unit 230 via line 255 and leaves via line 232 after losing some of its water to the manipulated solution which has less osmotic pressure (ie less salt concentration). The concentrated, high pressure stream 232 enters an energy recovery turbine 240 transferring its hydraulic energy and leaves via line 241 as a rejected effluent from the process. The diluted manipulated solution leaves unit 230 via line 231 to enter unit 240 gaining hydraulic energy and leaves at a higher pressure via line 242 to enter another MO unit 220.

The manipulated solution at high pressure in the first loop, after losing some of its water through the membrane, leaves unit 220 via line 222 to enter an energy recovery turbine 260 which connects the two loops and allows line 222 to gain more hydraulic energy derived from line 212 in the second loop. The line 222 after gaining more energy via 260 enters another energy recovery device 250 where it transfers its hydraulic energy to the feed stream. Seawater or brackish water (the feed stream) enters the process via line 251 and leaves the energy recovery turbine 250 at higher pressure via line 253 to the main pump 254 and leaves via line 255 to enter unit 230. A recycle stream 233 takes some of the reject (high concentration) material from unit 230 back to the feed stream at a point between the energy recovery turbine 250 and pump 254. Referring to unit 220, this contains another manipulated solution at a lower concentration, the diluted solution leaves via line 221 to enter pump 213 and from the pump enters the RO unit 210. In unit 210, the second diluted manipulated solution will be separated into two streams. Fresh water could be produced and collected via line 211 whereas the rejected streams at high pressure leaves via line 212 and enters the energy recovery turbine 260 leaving at lower pressure via line 214 back to unit 220.

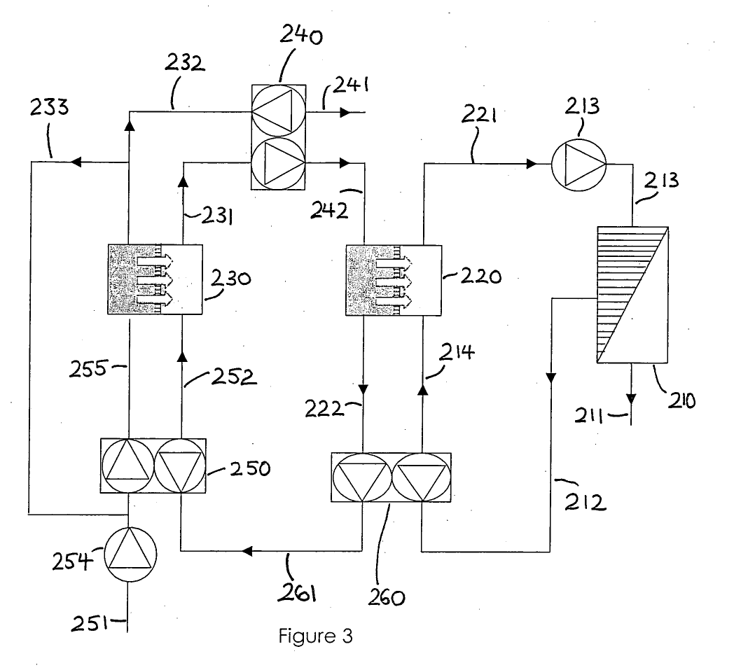

To assist in understanding this process further, FIG. 3 illustrates the arrangement shown in FIG. 2, in which typical operating pressures and typical operating concentrations are shown superimposed at strategic points around the system. A corresponding numbering system has been used to that in FIG. 2.

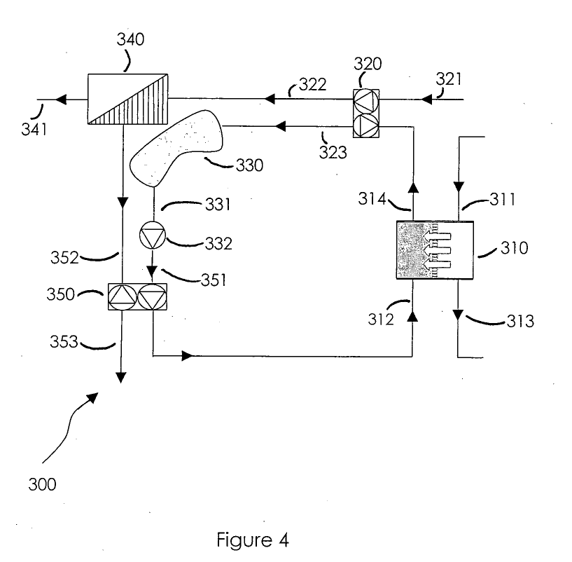

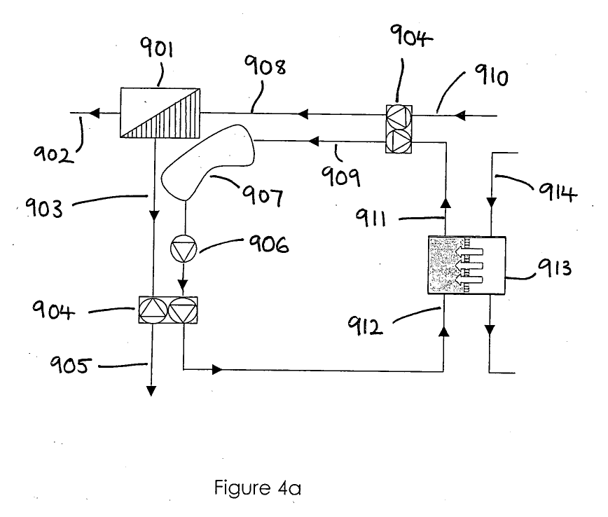

A second aspect of the present invention is illustrated in FIGS. 4 to 7 inclusive.

Referring to FIG. 4, this illustrates an osmotic energy recovery system 300. A Forward Osmosis unit 310 has two different concentration solutions separated by a semi-permeable membrane and such a unit is described in my patent WO 2005/012185 and WO 2005/120688.

As for the low concentration side, a first solution consisting of an untreated water source 311 enters the Unit. This could consist of brackish water, seawater, waste water or any untreated water. Some of the solvent (water) passes through the membrane into the second solution and the rest leaves the Unit through line 313.

Line 314 from the Forward Osmosis Unit which is at high pressure enters an Energy Recovery Turbine unit 320 and leaves along line 323 after transferring its pressure to the feed stream which enters the unit through 321. Line 321 could be any form of untreated water such as brackish water, seawater, waste water or any untreated water. Line 323 takes the depressurised second solution from unit 320 to a solar pond 330.

The untreated water leaves the Energy Recovery Turbine 320 at high pressure through line 322 and then enters an RO unit 340 as a fourth solution which produces fresh water as a third solution through line 341, whereas the rejected pressurised stream leaves the RO unit via 352 and enters a second Energy Recovery Turbine unit 350. The high concentration solution from solar pond 330 enters an auxiliary pump 332 via line 331. This solution is pressurised through unit 350 by gaining its pressure from the RO unit's rejected stream which leaves via line 353 and may be forwarded to unit 330. The high pressure stream coming out from unit 350 enters the unit 310 which is at a high pressure via line 312.

To assist in understanding this process further, the key to FIG. 4, at the end of this description, illustrates the arrangement shown in FIG. 4, in which typical operating pressures and typical operating concentrations are shown superimposed at strategic points around the system. This is also illustrated in FIG. 4a in which a corresponding numbering system has been used to that in FIG. 4.

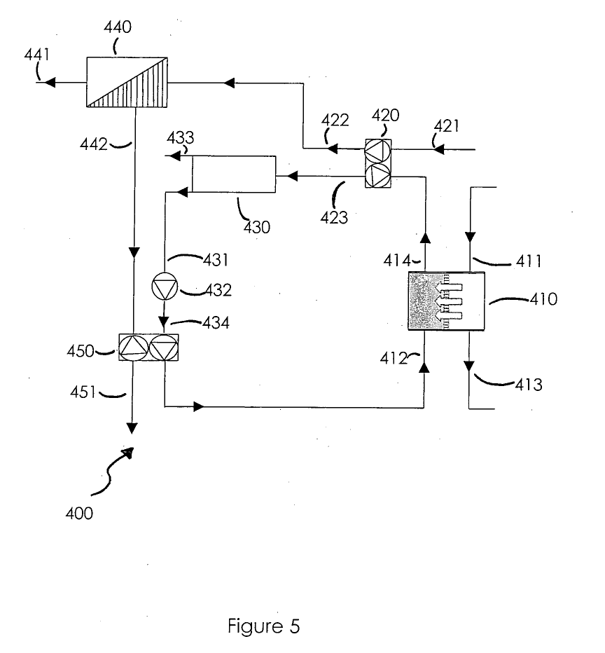

Referring to FIG. 5, this illustrates a further preferred embodiment of an osmotic energy recovery system. All the units 410, 420, 440 and 450 are similar to those units in FIG. 4, namely 310,320,340 and 350. The only difference is that Unit 430 could be used with any thermal desalination plant 430 such as MSF, MED or VC. Line 433 transfers the distilled water out of the unit and line 431 takes the concentrated solution out from the unit to an auxiliary pump 431 and finally to the Energy Recovery Turbine 450. Other lines are the same as those described in FIG. 4 layout and with similar numbering and explanations.

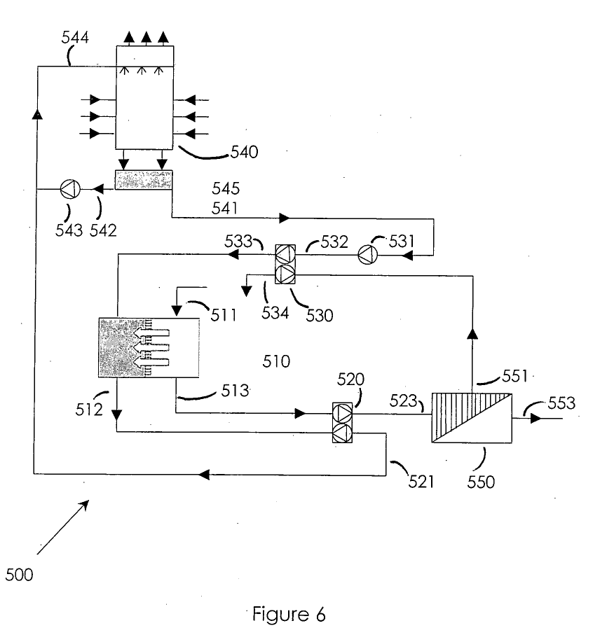

Referring to FIG. 6, this illustrates a further preferred osmotic energy recovery system 500. The concept of the process is the same as that described above in FIG. 4 and FIG. 5. However, in this embodiment, the source of concentration is a cooling tower unit 540. Unit 540 could be any type of evaporative cooling tower. The high concentrated solution leaves the cooling tower basin 545 via line 541 to an auxiliary pump 531 and then to the Energy Recovery Turbine Unit 530 via line 532. The high concentration solution is pressurised, leaving unit 530, to enter the Forward Osmosis unit 510 via line 533 as a second solution. Cooling Tower feed water enters unit 510 through line 511. The source of the water could be any available water source such as river water, waste water, brackish water, seawater or any untreated water. A pure solvent (water) passes through the semi-permeable membrane from the lower concentration side, solution one, to the higher concentration side, solution 2. The low concentration stream 513 enters a Energy Recovery Turbine unit 520 to be pressurised and then enters the RO unit 550 via line 523 as solution four. Fresh water leaves the unit 550 via line 553 as solution three whereas the rejected stream 551 transfers its pressure to the concentrated stream in unit 530 and is then dismissed. The pumped concentrated solution leaves from unit 520 back to the cooling tower via line 521 and is then mixed with recirculation water line 542 after pumping by the recirculating pump 543. Both lines 521 and 542 come together in line 544 which sprays the recirculation water inside the cooling tower unit 540.

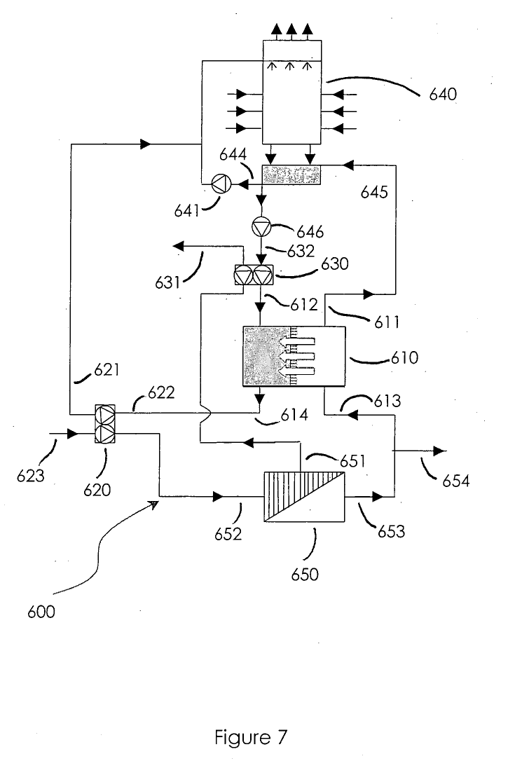

Referring to FIG. 7, this illustrates a further embodiment, somewhat different to the arrangement in FIG. 6 in that it is used to minimize the contamination through the forward osmosis unit 610 by means of feeding it with the fresh permeated water produced by RO unit 650. An excess of fresh water is also produced in this process. The concentrated stream from cooling tower unit 640 is pumped by an auxiliary pump 646 and is then directed to the Energy Recovery Turbine unit 630 via line 612. The concentrated stream leaves 630 at high pressure and enters the forward osmosis unit 610 via line 612. Unit 630 transfers hydraulic energy from the rejected stream that comes out form the RO unit 650 via line 651 to the concentrated stream line 612. The depressurised rejected steam leaves the process via line 631 and is dismissed.

The high pressure concentrated stream leaves unit 610 via line 614 after increasing its flow rate by dilution with pure water which passes across the semi-permeable membrane of the Forward Osmosis unit 610, due to the osmotic pressure differences between the two solutions. Line 614 enters the second Energy Recovery Turbine unit 620 and leaves at lower pressure to return back to the cooling tower via line 621. The feed water enters Unit 620 via line 623 and leaves at higher pressure to the RO Unit 650 where it is separated into two streams.

The pure water (permeate) 653 from the RO unit 650 enters the unit 610 leaving at a lower flow rate as some of its water (solvent) passes to the other side of the membrane. The outlet stream is directed back to the cooling tower 640. Any excess of pure water can be taken via line 654 as a product. The feed water to the cooling tower line 621 is mixed with the recirculation water which comes out from pump 641.

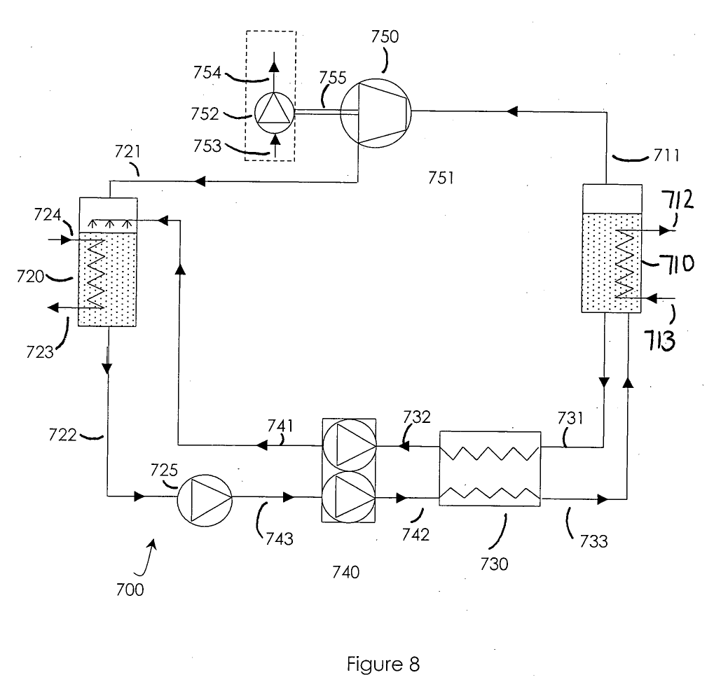

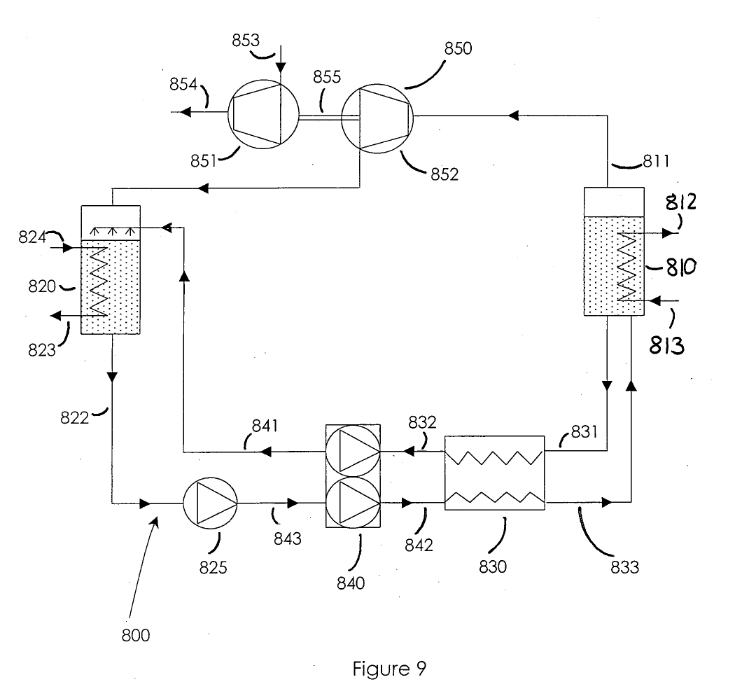

A third aspect of the present invention is illustrated in FIGS. 8 and 9. Referring to FIG. 8, this shows in schematic form an ammonia—water engine (Mayahi Cycle) 700. An evaporator 710 is heated by a heating source which enters the evaporator via line 712 and leaves via line 713. The evaporator 110 contains a liquid solution of ammonia dissolved in water in the presence of its vapour over the surface of the liquid. The vapour leaves unit 710 through line 711 and enters a turbine 750 at high pressure. It will leave the turbine 750 through line 721 at low pressure after converting its mechanical energy to run a pump 752. The body of the turbine 751 is connected to the pump 752 through a solid shaft 755. Any liquid stream can be pumped by pump 752, entering the pump through 753 and leaving at higher pressure through line 754. The vapour then condenses in condenser 720 (ammonia absorber). Condenser 720 is cooled by a cooling source which enters the condenser via 724 and leaves via 723.

To keep the process running, the concentration and amount of ammonia solution of both evaporator 710 and condenser 720 should remain substantially the same. To resolve this, a portion of the liquid from the condenser 720 is transferred to the evaporator 710 and visa versa an equal portion of the liquid from the evaporator 710 is transferred to the condenser 720. The transfer of these liquids is done with the aid of an Energy Recovery Turbine 740 exchanging the high pressure of one liquid with the low pressure of the other. The high pressure stream from evaporator 710 leaves through line 731 and enters a heat exchanger 730 and leaves it via line 732 to enter the Energy Recovery Turbine 740 and leaves it at low pressure via line 741 to the condenser 720. The low pressure stream from condenser 720 leaves through line 722 to enter an auxiliary pump 725 and leaves it via line 743 to enter the Energy Recovery Turbine 740 and leaves it at high pressure via line 742 and enters a heat exchanger 730 and leaves via line 733 to enter evaporator 710.

Referring to FIG. 9, this shows in schematic form a further ammonia—water engine (Mayahi Cycle) 800. An evaporator 810 is heated by a heating source enters via line 812 and leaves via line 813. The evaporator 810 contains a liquid solution of ammonia dissolved in water in the presence of its vapour over the surface of the liquid. The vapour leaves unit 810 through line 811 and enters a turbine 850 at high pressure. It leaves the turbine 850 through line 821 at low pressure after converting its mechanical energy to run a vapour compressor 852. The turbine 851 is connected to a compressor 852 through a solid shaft 855. Any gas or vapour to be compressed enters through line 853 and leaves at higher pressure through line 854.

The vapour then condenses in condenser 820 (ammonia absorber). Condenser 820 is cooled by a cooling source which enters via 824 and leaves via 823.

To keep the process running, the concentration and amount of ammonia solution of evaporator 810 and condenser 820 should remain substantially the same. To resolve this a portion of the liquid from the condenser 820 is transferred to the evaporator 810 and visa versa an equal portion of the liquid from the evaporator 810 is transferred to the condenser 820. The transfer of these liquids is done via the aid of an Energy Recovery Turbine 840, exchanging the high pressure of one liquid with the low pressure of the other. The high pressure stream from evaporator 810 leaves through line 831 and enters a heat exchanger 830 and leaves it via line 832 to enter the Energy Recovery Turbine 840 and leaves it at low pressure via line 841 to the condenser 820. The low pressure stream from condenser 820 leaves through line 822 to enter an auxiliary pump 825 and leaves it via line 843 to enter the Energy Recovery Turbine 840 and leaves it at high pressure via line 842 and enters a heat exchanger 830 and leaves via line 833 to enter evaporator 810.

By way of information, Tables 1 and 2 show in tabulated form the concentration—temperature—pressure measurements for ammonia/water equilibrium in both pounds per square inch (psi) in Table 1 and atmospheres (bar) in Table 2.

### Key to FIG. 3

210 RO or MO Unit
211 Fresh water (permeate), 0%
212 3%, 12-22 bar
213 pump, 1.5%, 15-25 bar
214 3%
220,230 MO Units working as RO
221 1.5%
222 4%, 22-35 bar
231 2.5%, 1-2 bar
232 28-38 bar
233 recycled stream
232+233 6%
240 ERD
241 rejected, 6%
242 2.5%, 28-38 bar
250 ERD
251 Feed (sea water of brackish water), c=4%
252 2-3 bar, 4%
254 pump, p=15-25 bar
255 4%, p=30-40 bar
260 ERD
261 35-45 bar

### Key to FIG. 4

310 Forward Osmosis FO Unit, the low concentration side at low pressure and high concentration side at higher pressure
320, 350 Energy Recovery Turbines
330 Solar Pond (concentrator)
340 RO Unit (conventional)
311 any available water stream to dilute and drive the FO unit. C=0-3%, p=normal
321 any untreated stream (feed) such as brackish or sea water, c=1-4%, p=normal
312 concentrated stream, P=10−70 bar, c=5-25%, flow rate=V m3/hr
314 diluted stream out from the FO unit, P=8-68 bar, c=2-12%, flow rate=1.5-3 V m3/hr
323 non-pressurized stream
322 pressurized RO feed stream, P=6-66 bar, c=0-3%, flow rate==1.5-3 V m3/hr
431 Permeate, non pressurized, flow rate=1-2 V m3/hr
352 rejected stream, p=5-64 bar, flow rate=0.5-1.5 V m3/hr
332 auxiliary pump, P=1-5 bar, flow rate=V m3/hr
353 non-pressurized rejected stream

### Key to FIG. 4a

901 RO Unit
902 Fresh water (permeate), P=normal, flow rate=1-2 Vm³/hr
903 Rejected stream, P=5-64 bar, flow rate=0.5-1.5 V
904 Energy Recovery Turbine
905 Reject, P=normal
906 auxiliary pump, P=1-10 bar, flow rate=Vm³/hr
907 Solar Pond,
908 RO Feed, P=6-66 bar, C=0-4%, flow rate=1.5-3
909 P=normal, C=2-12%
910 Untreated water, C=0-4%, P=normal
911 Diluted stream out of FO, P=8-68 bar, C=2-12%, flow rate=1.5-3Vm³/hr
912 Concentrated stream, P=10-70 bar, C=5-25%, flow rate=
913 FO Unit
914 Dilution water, C=0-3%, P=Normal

Pressures are in pounds per square inch absolute

| | Molal concentration of ammonia in the solutions in percentages | | | | | | | | | | | |
|---|---|---|---|---|---|---|---|---|---|---|---|---|
| | (Weight concentration of ammonia in the solutions in percentages) | | | | | | | | | | | |
| | 0 | 5 | 10 | 15 | 20 | 25 | 30 | 35 | 40 | 45 | 50 | 55 |
| t, ° F. | (0) | (4.74) | (9.50) | (14.29) | (19.10) | (23.94) | (28.81) | (33.71) | (38.64) | (43.59) | (48.57) | (53.58) |
| 32 | 0.09 | 0.34 | 0.60 | 0.97 | 1.58 | 2.60 | 4.20 | 6.54 | 9.93 | 14.18 | 19.40 | 25.16 |
| 40 | 0.12 | 0.45 | 0.77 | 1.24 | 2.01 | 3.25 | 5.21 | 8.06 | 12.05 | 17.20 | 23.39 | 30.20 |
| 50 | 0.18 | 0.64 | 1.05 | 1.65 | 2.67 | 4.29 | 6.75 | 10.35 | 15.34 | 21.65 | 29.26 | 37.54 |
| 60 | 0.26 | 0.86 | 1.42 | 2.21 | 3.51 | 5.55 | 8.65 | 13.22 | 19.30 | 27.05 | 36.26 | 46.23 |
| 70 | 0.36 | 1.17 | 1.84 | 2.90 | 4.56 | 7.13 | 11.01 | 16.56 | 24.05 | 33.39 | 44.42 | 56.44 |
| 80 | 0.51 | 1.52 | 2.43 | 3.76 | 5.85 | 9.06 | 13.86 | 20.61 | 29.69 | 40.96 | 54.08 | 68.19 |
| 90 | 0.70 | 2.02 | 3.15 | 4.83 | 7.43 | 11.40 | 17.23 | 25.48 | 36.34 | 49.82 | 65.32 | 81.91 |
| 100 | 0.95 | 2.62 | 4.05 | 6.13 | 9.34 | 14.22 | 21.32 | 31.16 | 44.12 | 59.99 | 78.30 | 97.68 |
| 110 | 1.27 | 3.34 | 5.14 | 7.72 | 11.64 | 17.58 | 26.07 | 37.81 | 53.16 | 71.87 | 93.19 | 115.70 |
| 120 | 1.69 | 4.27 | 6.46 | 9.63 | 14.42 | 21.54 | 31.69 | 45.62 | 63.59 | 85.33 | 110.20 | 136.20 |
| 130 | 2.22 | 5.38 | 8.07 | 11.91 | 17.67 | 26.20 | 38.25 | 54.55 | 75.55 | 100.86 | 129.50 | 159.00 |
| 140 | 2.89 | 6.70 | 9.98 | 14.63 | 21.49 | 31.54 | 45.73 | 64.78 | 89.19 | 118.24 | 151.30 | 185.40 |
| 150 | 3.72 | 8.29 | 12.23 | 17.81 | 26.00 | 37.81 | 54.43 | 76.61 | 104.65 | 138.10 | 175.40 | 214.50 |
| 160 | 4.74 | 10.16 | 14.92 | 21.54 | 31.16 | 45.02 | 64.25 | 89.88 | 122.10 | 160.20 | 202.70 | 247.00 |
| 170 | 5.99 | 12.41 | 18.01 | 25.87 | 37.11 | 53.27 | 75.55 | 104.84 | 141.75 | 185.10 | 233.20 | 283.10 |
| 180 | 7.51 | 15.00 | 21.65 | 30.86 | 44.02 | 62.68 | 88.17 | 121.68 | 163.70 | 212.60 | 267.00 | 323.10 |
| 190 | 9.34 | 18.06 | 25.87 | 36.60 | 51.81 | 73.32 | 102.56 | 140.75 | 188.10 | 243.30 | 304.30 | 367.10 |
| 200 | 11.53 | 21.60 | 30.72 | 43.14 | 60.62 | 85.33 | 118.68 | 161.81 | 215.20 | 277.00 | 345.50 | 415.10 |
| 210 | 14.12 | 25.61 | 36.26 | 50.58 | 70.72 | 98.80 | 136.42 | 185.10 | 245.10 | 314.50 | 390.70 | 468.40 |
| 220 | 17.19 | 30.27 | 42.47 | 59.00 | 81.91 | 113.81 | 156.41 | 211.24 | 278.20 | 355.10 | 439.60 | 525.50 |
| 230 | 20.78 | 35.59 | 49.60 | 68.46 | 94.43 | 130.64 | 178.28 | 239.70 | 314.50 | 400.20 | 493.40 | |
| 240 | 24.97 | 41.52 | 57.65 | 78.91 | 108.60 | 149.20 | 202.74 | 270.92 | 354.10 | 448.90 | 552.30 | |
| 250 | 29.83 | 48.32 | 66.67 | 90.74 | 124.08 | 169.48 | 229.62 | 305.60 | 397.60 | 502.40 | | |

| | Molal concentration of ammonia in the solutions in percentages | | | | | | | | |
|---|---|---|---|---|---|---|---|---|---|
| | (Weight concentration of ammonia in the solutions in percentages) | | | | | | | | |
| | 60 | 65 | 70 | 75 | 80 | 85 | 90 | 95 | 100 |
| t, ° F. | (58.62) | (63.69) | (68.79) | (73.91) | (79.07) | (84.26) | (89.47) | (94.72) | (100.00) |
| 32 | 31.16 | 36.77 | 42.72 | 45.94 | 49.28 | 52.14 | 54.90 | 58.01 | 62.29 |
| 40 | 37.20 | 43.73 | 49.60 | 54.43 | 58.33 | 61.64 | 64.78 | 68.32 | 73.32 |
| 50 | 45.93 | 53.85 | 60.87 | 66.67 | 71.29 | 75.25 | 79.07 | 83.41 | 89.19 |
| 60 | 56.32 | 65.90 | 74.06 | 80.96 | 86.49 | 91.08 | 95.69 | 100.66 | 107.60 |
| 70 | 68.46 | 79.54 | 89.36 | 97.51 | 104.08 | 109.60 | 114.86 | 120.63 | 128.80 |
| 80 | 82.55 | 95.69 | 107.20 | 116.54 | 124.30 | 130.64 | 136.40 | 143.72 | 153.00 |
| 90 | 98.61 | 114.02 | 127.42 | 138.34 | 147.15 | 154.56 | 161.81 | 169.76 | 180.60 |
| 100 | 117.17 | 135.01 | 150.50 | 163.16 | 173.40 | 182.10 | 190.22 | 199.22 | 211.90 |
| 110 | 138.10 | 158.84 | 176.54 | 191.15 | 203.26 | 212.89 | 222.34 | 232.85 | 247.00 |
| 120 | 162.08 | 185.70 | 206.29 | 222.68 | 236.37 | 247.38 | 258.40 | 270.10 | 286.40 |
| 130 | 189.00 | 215.88 | 239.33 | 258.40 | 273.30 | 286.40 | 298.67 | 311.90 | 330.30 |
| 140 | 219.28 | 249.66 | 276.15 | 297.81 | 315.00 | 329.40 | 343.20 | 358.60 | 379.10 |
| 150 | 252.65 | 287.24 | 317.30 | 341.70 | 361.10 | 377.10 | 392.80 | 409.80 | 432.20 |
| 160 | 290.18 | 329.40 | 363.10 | 390.20 | 412.20 | 430.40 | 447.80 | 466.60 | 492.80 |
| 170 | 331.70 | 375.60 | 413.30 | 443.70 | 467.80 | 488.70 | 508.20 | 528.80 | 558.40 |
| 180 | 377.10 | 426.60 | 468.40 | 502.40 | 529.50 | 552.30 | | | |
| 190 | 427.70 | 452.50 | 528.80 | | | | | | |
| 200 | 483.00 | 543.60 | | | | | | | |
| 210 | 542.90 | | | | | | | | |
| 220 | | | | | | | | | |
| 230 | | | | | | | | | |
| 240 | | | | | | | | | |
| 250 | | | | | | | | | |

Pressures are in bars

| | Molal concentration of ammonia in the solutions in percentages | | | | | | | | | | | |
|---|---|---|---|---|---|---|---|---|---|---|---|---|
| | (Weight concentration of ammonia in the solutions in percentages) | | | | | | | | | | | |
| | 0 | 5 | 10 | 15 | 20 | 25 | 30 | 35 | 40 | 45 | 50 | 55 |
| t, ° F. | (0) | (4.74) | (9.50) | (14.29) | (19.10) | (23.94) | (28.81) | (33.71) | (38.64) | (43.59) | (48.57) | (53.58) |
| 0 | 0.006 | 0.023 | 0.041 | 0.066 | 0.107 | 0.177 | 0.286 | 0.445 | 0.676 | 0.965 | 1.32 | 1.712 |
| 4.444 | 0.008 | 0.031 | 0.052 | 0.084 | 0.137 | 0.221 | 0.354 | 0.548 | 0.82 | 1.17 | 1.591 | 2.054 |
| 10 | 0.012 | 0.044 | 0.071 | 0.112 | 0.182 | 0.292 | 0.459 | 0.704 | 1.044 | 1.473 | 1.99 | 2.554 |
| 15.56 | 0.018 | 0.059 | 0.097 | 0.15 | 0.239 | 0.378 | 0.588 | 0.899 | 1.313 | 1.84 | 2.467 | 3.145 |
| 21.11 | 0.024 | 0.08 | 0.125 | 0.197 | 0.31 | 0.485 | 0.749 | 1.127 | 1.636 | 2.271 | 3.022 | 3.839 |
| 26.67 | 0.035 | 0.103 | 0.165 | 0.256 | 0.398 | 0.616 | 0.943 | 1.402 | 2.02 | 2.786 | 3.679 | 4.639 |
| 32.22 | 0.048 | 0.137 | 0.214 | 0.329 | 0.505 | 0.776 | 1.172 | 1.733 | 2.472 | 3.389 | 4.444 | 5.572 |
| 37.78 | 0.065 | 0.178 | 0.276 | 0.417 | 0.635 | 0.967 | 1.45 | 2.12 | 3.001 | 4.081 | 5.327 | 6.645 |
| 43.33 | 0.086 | 0.227 | 0.35 | 0.525 | 0.792 | 1.196 | 1.773 | 2.572 | 3.616 | 4.889 | 6.339 | 7.871 |
| 48.89 | 0.115 | 0.29 | 0.439 | 0.655 | 0.981 | 1.465 | 2.156 | 3.103 | 4.326 | 5.805 | 7.497 | 9.265 |
| 54.44 | 0.151 | 0.366 | 0.549 | 0.81 | 1.202 | 1.782 | 2.602 | 3.711 | 5.139 | 6.861 | 8.81 | 10.82 |
| 60 | 0.197 | 0.456 | 0.679 | 0.995 | 1.462 | 2.146 | 3.111 | 4.407 | 6.067 | 8.044 | 10.29 | 12.61 |
| 65.56 | 0.253 | 0.564 | 0.832 | 1.212 | 1.769 | 2.572 | 3.703 | 5.212 | 7.119 | 9.395 | 11.93 | 14.59 |
| 71.11 | 0.322 | 0.691 | 1.015 | 1.465 | 2.12 | 3.063 | 4.371 | 6.114 | 8.306 | 10.9 | 13.79 | 16.8 |
| 76.67 | 0.407 | 0.844 | 1.225 | 1.76 | 2.524 | 3.624 | 5.139 | 7.132 | 9.643 | 12.59 | 15.86 | 19.26 |
| 82.22 | 0.511 | 1.02 | 1.473 | 2.099 | 2.995 | 4.264 | 5.998 | 8.278 | 11.14 | 14.46 | 18.16 | 21.98 |
| 87.78 | 0.635 | 1.229 | 1.76 | 2.49 | 3.524 | 4.988 | 6.977 | 9.575 | 12.8 | 16.55 | 20.7 | 24.97 |
| 93.33 | 0.784 | 1.469 | 2.09 | 2.935 | 4.124 | 5.805 | 8.073 | 11.01 | 14.64 | 18.84 | 23.5 | 28.24 |
| 98.89 | 0.961 | 1.742 | 2.467 | 3.441 | 4.811 | 6.721 | 9.28 | 12.59 | 16.67 | 21.39 | 26.58 | 31.86 |
| 104.4 | 1.169 | 2.059 | 2.889 | 4.014 | 5.572 | 7.742 | 10.64 | 14.37 | 18.93 | 24.16 | 29.9 | 35.75 |
| 110 | 1.414 | 2.421 | 3.374 | 4.657 | 6.424 | 8.887 | 12.13 | 16.31 | 21.39 | 27.22 | 33.56 | |
| 115.6 | 1.699 | 2.824 | 3.922 | 5.368 | 7.388 | 10.15 | 13.79 | 18.43 | 24.09 | 30.54 | 37.57 | |
| 121.1 | 2.029 | 3.287 | 4.535 | 6.173 | 8.441 | 11.53 | 15.62 | 20.79 | 27.05 | 34.18 | | |

| | Molal concentration of ammonia in the solutions in percentages | | | | | | | | |
|---|---|---|---|---|---|---|---|---|---|
| | (Weight concentration of ammonia in the solutions in percentages) | | | | | | | | |
| | 60 | 65 | 70 | 75 | 80 | 85 | 90 | 95 | 100 |
| t, ° F. | (58.62) | (63.69) | (68.79) | (73.91) | (79.07) | (84.26) | (89.47) | (94.72) | (100.00) |
| 0 | 2.12 | 2.501 | 2.906 | 3.125 | 3.352 | 3.547 | 3.735 | 3.946 | 4.237 |
| 4.444 | 2.531 | 2.975 | 3.374 | 3.703 | 3.968 | 4.193 | 4.407 | 4.648 | 4.988 |
| 10 | 3.124 | 3.663 | 4.141 | 4.535 | 4.85 | 5.119 | 5.379 | 5.674 | 6.067 |
| 15.56 | 3.831 | 4.483 | 5.038 | 5.507 | 5.884 | 6.196 | 6.51 | 6.848 | 7.32 |
| 21.11 | 4.657 | 5.411 | 6.079 | 6.633 | 7.08 | 7.456 | 7.814 | 8.206 | 8.762 |
| 26.67 | 5.616 | 6.51 | 7.293 | 7.928 | 8.456 | 8.887 | 9.279 | 9.777 | 10.41 |
| 32.22 | 6.708 | 7.756 | 8.668 | 9.411 | 10.01 | 10.51 | 11.01 | 11.55 | 12.29 |
| 37.78 | 7.971 | 9.184 | 10.24 | 11.1 | 11.8 | 12.39 | 12.94 | 13.55 | 14.41 |
| 43.33 | 9.395 | 10.81 | 12.01 | 13 | 13.83 | 14.48 | 15.13 | 15.84 | 16.8 |
| 48.89 | 11.03 | 12.63 | 14.03 | 15.15 | 16.08 | 16.83 | 17.58 | 18.37 | 19.48 |
| 54.44 | 12.86 | 14.69 | 16.28 | 17.58 | 18.59 | 19.48 | 20.32 | 21.22 | 22.47 |
| 60 | 14.92 | 16.98 | 18.79 | 20.26 | 21.43 | 22.41 | 23.35 | 24.39 | 25.79 |
| 65.56 | 17.19 | 19.54 | 21.59 | 23.24 | 24.56 | 25.65 | 26.72 | 27.88 | 29.4 |
| 71.11 | 19.74 | 22.41 | 24.7 | 26.54 | 28.04 | 29.28 | 30.46 | 31.74 | 33.52 |
| 76.67 | 22.56 | 25.55 | 28.12 | 30.18 | 31.82 | 33.24 | 34.57 | 35.97 | 37.99 |
| 82.22 | 25.65 | 29.02 | 31.86 | 34.18 | 36.02 | 37.57 | | | |
| 87.78 | 29.1 | 30.78 | 35.97 | | | | | | |
| 93.33 | 32.86 | 36.98 | | | | | | | |
| 98.89 | 36.93 | | | | | | | | |
| 104.4 | | | | | | | | | |
| 110 | | | | | | | | | |
| 115.6 | | | | | | | | | |
| 121.1 | | | | | | | | | |

1. An apparatus for recovering energy from an osmotic system, said apparatus comprising:
(i) a feed stream;
(ii) a pressurising unit to pressurise said feed stream;
(iii) a manipulated osmosis unit working according to reverse osmosis principles;
(iv) an energy recovery unit in fluid connection with second solution side of the manipulated osmosis unit; and
(v) a reverse osmosis unit receiving a feed from the energy recovery unit.

2. An apparatus according to claim 1 wherein said manipulated osmosis unit houses a selective membrane for separating a first solution from a second solution, said membrane being configured to selectively allow solvent to pass from the first solution side of the membrane to the second solution side of the membrane.

3. An apparatus according to claim 1 wherein the reverse osmosis unit houses a second selective membrane for separating a third solution from a fourth solution, said second membrane being configured to selectively allow solvent to pass from the said third solution to said fourth solution.

4. An apparatus according to claim 1 wherein the pressurising unit comprises a pump.

5. An apparatus according to claim 1 wherein the pressurising unit comprises an energy recovery unit.

6. An apparatus according to claim 5 wherein the pressurising unit comprises an energy recovery unit and a pump.

7. An apparatus according to claim 5 wherein the energy recovery unit comprises an energy recovery turbine.

8. An apparatus according to claim 1 wherein said apparatus further comprises a second manipulated osmosis unit.

9. An apparatus according to claim 8 wherein the second manipulated osmosis unit houses a third selective membrane for separating a fifth solution from a sixth solution, said membrane being configured to selectively allow solvent to pass from the fifth solution side of the membrane to the sixth solution side of the membrane.

10. An apparatus according to claim 8 wherein the first and second manipulated osmosis units are connected in a loop.

11. An apparatus as claimed in claim 10 wherein a feed stream is provided to the first solution in said first manipulated osmosis unit and said second solution provides a feed to the fifth solution in said second manipulated osmosis unit.

12. An apparatus as claimed in claim 11 wherein said feed to the fifth solution proceeds via an energy transfer unit.

13. An apparatus as claimed in claim 11 wherein said sixth solution provides a feed to the third solution in the reverse osmosis unit.

14. An apparatus as claimed in claim 13 wherein said feed proceeds to the reverse osmosis unit via a pump.

15. An apparatus as claimed in claim 8 further comprising a second energy recovery unit.

16. An apparatus as claimed in claim 15 wherein the second energy recovery unit is in fluid connection with the second manipulated osmosis unit and with the reverse osmosis unit.

17. An apparatus as claimed in claim 15 wherein one or more of the energy recovery units comprise an energy recovery turbine.

18. (canceled)

19. A process for recovering energy from an osmotic system, said process comprising:—
positioning a selective membrane in a manipulated osmosis unit working according to reverse osmosis principles between a first solution and a second solution, such that the solvent from the first solution passes across the membrane to dilute the second solution;
(ii) providing a feed stream to the first solution in the manipulated osmosis unit;
(iii) extracting solvent from the second solution using a reverse osmosis unit, a feed line connecting the second solution in the manipulated osmosis unit and the reverse osmosis unit; and
(iv) providing an energy recovery unit in the feed line between the manipulated osmosis unit and the reverse osmosis unit.

20. A process according to claim 19 wherein a pressurising unit is provided to pressurise the feed stream into the manipulated osmosis unit.

21. A process according to claim 20 wherein the pressurising unit comprises either a pump, or an energy transfer unit, or both.

22. A process according to claim 19 wherein the second solution from the manipulated osmosis unit is directed to a second manipulated osmosis unit.

23. A process as claimed in claim 22 wherein the first manipulated osmosis unit and the second manipulated osmosis unit are connected in a loop.

24. A process according to claim 23 wherein energy recovery units are positioned/located between the respective osmosis units.

25. A process for recovering energy from an osmotic system comprising providing and operating an apparatus according to claim 1.

26. (canceled)

27. An osmotic energy recovery apparatus, said apparatus comprising:—
(i) a first feed stream;
(ii) a first, forward osmosis unit;
(iii) a first energy transfer unit located on an exit stream from the forward osmosis unit;
(iv) a second, reverse osmosis unit; and
(v) a second energy transfer unit located adapted to derive energy from the high pressure side of the reverse osmosis unit.

28. An apparatus as claimed in claim 27 wherein said forward osmosis unit houses a first selective membrane for separating a first solution from a second solution, said first membrane being configured to selectively allow solvent to pass from said first solution to said second solution and thus to build up pressure in the second solution.

29. An apparatus as claimed in claim 27 wherein said second osmosis unit houses a second selective membrane for separating a third solution from a fourth solution, said second membrane being configured to selectively allow solvent to pass from said fourth solution to said third solution; said second osmosis unit receiving a feed stream pressurised by the energy transfer unit.

30. An apparatus as claimed in claim 27 further comprising a solar pond, said solar pond receiving the second solution from the first osmosis unit by way of the first energy transfer unit.

31. An apparatus as claimed in claim 30 further comprising a pump to raise water from the solar pond.

32. An apparatus as claimed in claim 27 further comprising a desalination plant, said desalination plant receiving the second solution from the first osmosis unit by way of the first energy transfer unit.

33. An apparatus as claimed in claim 32 further comprising a pump to deliver a fluid stream from the desalination plant towards the first osmosis unit via the second energy transfer unit.

34. An apparatus as claimed in claim 27 wherein the second solution in the first osmosis unit, the first energy transfer unit, and the second energy transfer unit form a loop.

35. An apparatus as claimed in claim 27 further comprising a cooling tower.

36. An apparatus as claimed in claim 35 wherein the second solution in the first osmosis unit, the first and second energy transfer unit and the cooling tower form a loop.

37. (canceled)

38. A process for recovering energy from an osmotic system said process comprising:—
(i) providing a first, forward osmosis unit;
(ii) providing a second, reverse osmosis unit;
(iii) providing a first energy transfer unit to transfer energy from an output stream from the forward osmosis unit to an input stream to the reverse osmosis unit; and
(iv) providing a second energy transfer unit to transfer energy from an output stream from the reverse osmosis unit to an input stream to the forward osmosis unit.

39. A process according to claim 38 wherein said first osmosis unit houses a first selective membrane for separating a first solution from a second solution, said first membrane being configured to selectively allow solvent to pass from said first solution to said second solution, and thus build up pressure in the second solution.

40. A process according to claim 38 wherein said reverse osmosis unit houses a second selective membrane for separating a third solution from a fourth solution, said second membrane being configured to selectively allow solvent to pass from said fourth solution to said third solution.

41. A process according to claim 38 further comprising providing a solar pond, said solar pond receiving an output from the forward osmosis unit by way of the first energy transfer unit.

42. A process according to claim 41 wherein a pump is located between the solar pond and an input to the forward osmosis unit to raise water from the pond.

43. A process according to claim 38 further comprising a desalination plant, said desalination plant receiving an output from the forward osmosis unit by way of the first energy transfer.

44. A process according to claim 38 in which a fluid loop is created between a more concentrated solution side of the forward osmosis unit, a first energy transfer unit, a source of concentration such as solar pond, desalination plant or a cooling tower, a second energy transfer unit, returning to the more concentrated solution side of the forward osmosis unit, said loop providing energy to an input stream for the reverse osmosis unit and deriving energy from an output stream from the reverse osmosis unit.

45. A process according to claim 44 wherein an output stream from a more dilute solution side of the reverse osmosis unit is directed as a feed into a more dilute side of the forward osmosis unit.

46. A process for recovering energy comprising providing an apparatus according to claim 27 and operating said process.

47. (canceled)

48. An ammonia-water engine apparatus, said apparatus comprising:—
(i) an evaporator containing a liquid solution of ammonia in water in the presence of a vapour over the liquid solution;
(ii) a heating source to heat the evaporator;
(iii) a turbine adapted to receive vapour from the evaporator;
(iv) a condenser adapted to condense vapour from the turbine to provide a condensate;
(v) an energy transfer unit adapted to derive energy from a condensate stream on route from the evaporator to the condenser; and
(vi) a heat exchanger adapted to heat the condensate stream.

49. An ammonia-water engine as claimed in claim 48 further comprising a high pressure feed from the liquid in the evaporator to the heat exchanger, said feed passing through the energy transfer unit where it leaves at a lower pressure on route to the condenser.

50. An ammonia-water engine as claimed in claim 48 further comprising an auxiliary pump.

51. An ammonia-water engine as claimed in claim 48 wherein the turbine is connected to a pump, the energy from the turbine being used to drive the pump.

52. An ammonia-water engine as claimed in claim 48 wherein the turbine is connected to a vapour compressor, the energy from the turbine being used to drive the compressor.

53. (canceled)
